(19) United States
(12) Patent Application Publication
(10) Pub. No.: US 2022/0084120 A1
(43) Pub. Date: Mar. 17, 2022

(54) TRADING PLATFORM FOR NON-MONETARY DIGITAL ASSETS

(71) Applicant: Wells Fargo Bank, N.A., San Francisco, CA (US)

(72) Inventors: Kav Khurana, Huntersville, NC (US); Christopher Nicholas Mair, Charlotte, NC (US); Claes Dahlstrand, Charlotte, NC (US); Lakshmi Kantamneni, Charlotte, NC (US); James E. Price, Bluffton, SC (US); Michael Edward Beaumont, Charlotte, NC (US); Gene C. Baker, JR., Eldersburg, MD (US); Donald Nevills, Huntersville, NC (US)

(21) Appl. No.: 15/162,891

(22) Filed: May 24, 2016

(51) Int. Cl. G06Q 40/06; G06Q 30/02; G06Q 40/04

(52) U.S. Cl. CPC G06Q 40/06; G06Q 40/04; G06Q 30/0201; G06Q 30/0206

(57) ABSTRACT

A system and computer-implemented method for use in generating retirement income from selling a non-monetary digital asset affiliated with a user are provided. Information about a user may be gathered by a processor in a computing device. A non-monetary digital asset associated with the user may be determined based on the user information. A market price for the non-monetary digital asset may be determined from a plurality of data sources. A buyer for the non-monetary digital asset may be identified. The non-monetary digital asset may then be sold to the buyer at the market value price. The proceeds from selling the non-monetary digital asset may be placed into a retirement account associated with the user. The non-monetary digital asset may be automatically sold at the market value price prior to an expiration date.

### TECHNICAL FIELD

The present application generally relates to a system and computer-implemented method for use as a tool in retirement income generation, more particularly to a system and computer-implemented method for use in generation of retirement income from selling a non-monetary digital asset.

### BACKGROUND

A digital asset may have either a monetary value or a non-monetary value. Virtual currencies, such as bitcoin or Litecoin, fall into the category of monetary assets, as would “in-game assets” for example, benefits, redeemable points, and/or currencies, which may have a value within an online game, platform, and/or a virtual community. Non-monetary assets, on the other hand, may include personal digital property, for example, photographs, correspondence, collections, and/or private information. Non-monetary assets typically have a subjective value. Although non-monetary assets do not have a specific exchangeable rate, non monetary assets may still have value, even if it is an arbitrary value.

A non-monetary digital asset may be an asset that exists in a binary format and comes with the right to use that asset. For example, a service provider may provide a consumer redeemable points for using a provided service. The service provider may assign a currency value to the points, for example, an airline fare may be obtained by redeeming a particular number of airline reward program mileage points. In most case, this currency value is used for internal accounting purposes associated with the service provider. The consumer points may also have a currency value external to the service provider. For example, a marketer, usually affiliated with the service provider, may provide a related good and service for purchase in return for a set number of consumer points. Points may be offered to a customer as an incentive for an ancillary purchase. For example, a credit card provider may allow a customer to convert points into a cash value on the credit card provider statement. Another provider may allow a customer to donate points to a charity which may provide a tax benefit to the customer.

Typically, a program involving points may have a constrained value. For example, a cell phone provider may offer minutes of calling time in exchange for a certain number of reward points for previously using a service provided by that cell phone provider. A gift card provider may offer a gift card containing value exchangeable only with a particular provider. An airline may allow miles to be redeemed for a ticket only on that airline.

The holder of a non-monetary digital asset may have limited options to redeem the acquired consumer points. The non-monetary digital asset may expire and/or may be of de minimis value to the consumer. Thus, obtaining value for the non-monetary digital asset may be problematic. As a result, there is a need for a system and computer-implemented method for the generation of retirement income from selling a non-monetary digital asset.

### BRIEF SUMMARY OF THE INVENTION

The present application relates to a computer-implemented method and system for use in the generation of retirement income from selling a non-monetary digital asset. With the present application, retirement income may be obtained from the sell a non-monetary digital asset affiliated with a user.

In an exemplary embodiment, the present application is related to a computer-implemented method for generating funds for retirement income growth using non-monetary digital assets. Information about a user may be gathered by a processor in a computing device. The processor may determine a non-monetary digital asset associated with the user based on the user information. A market price for the non-monetary digital asset may be determined from a plurality of data sources. A buyer for the non-monetary digital asset may be determined. The non-monetary digital asset may be sold to the buyer at the market value price. The proceeds from selling the non-monetary digital asset may be placed into a retirement account associated with the user.

In one embodiment of the method, the information about the user may comprise at least one of financial information, career information, and expenditure information.

In one embodiment of the method, the non-monetary digital asset associated with the user may comprise at least one of a service account, intellectual capital, and relational capital.

In one embodiment of the method, the market price may be determined from selling price information associated with a similar non-monetary digital asset and a redemption value associated with the non-monetary digital asset.

In one embodiment of the method, the identifying of a buyer may comprise advertising the non-monetary digital asset for sell, receiving an offer for the non-monetary digital asset from one or more potential buyers, and selecting the buyer based on an earliest offer received. The advertising of the non-monetary digital asset for sell may comprise identifying a type of the non-monetary digital asset, searching a database for a buyer who has indicated a desire to buy the type of the non-monetary digital asset, and providing the buyer information associated with the non-monetary digital asset.

In one embodiment of the method, a retirement goal for the user may be determined. A shortfall amount in the retirement income growth to meet the retirement goal may be estimated. An impact on the retirement income growth based on selling the non-monetary digital asset at the market value price may be estimated. One or more non-monetary digital assets may be identified for sell so as to reduce the shortfall amount in the retirement income growth. The one or more non-monetary digital assets may then be sold at the market value price.

In one embodiment of the method, the retirement income growth may be estimated based on selling the non-monetary digital asset at the market value price. A future market value price for non-monetary digital asset may be estimated. A recommendation to sell the non-monetary digital asset based on a greater value of the estimated retirement income growth for selling the non-monetary digital asset at the market value price than the estimated future market value price for non-monetary digital asset may be provided to the user.

In one embodiment of the method, the expiration date when non-monetary digital asset expires may be determined. A threshold sell after date for the non-monetary digital asset may be determined. The non-monetary digital asset may then be automatically sold after the threshold sell after date but before an expiration date for the non-monetary digital asset.

In another exemplary embodiment, the present application is related to a system for generating funds for retirement income growth using non-monetary digital assets. Information about a user may be gathered by a processor in a computing device. The processor may determine a non-monetary digital asset associated with the user based on the user information. A market price for the non-monetary digital asset may be determined from a plurality of data sources. A buyer for the non-monetary digital asset may be determined. The non-monetary digital asset may be sold to the buyer at the market value price. The proceeds from selling the non-monetary digital asset may be placed into a retirement account associated with the user.

In one embodiment of the system, the information about the user may comprise at least one of financial information, career information, and expenditure information.

In one embodiment of the system, the non-monetary digital asset associated with the user may comprise at least one of a service account, intellectual capital, and relational capital.

In one embodiment of the system, the market price may be determined from selling price information associated with a similar non-monetary digital asset and a redemption value associated with the non-monetary digital asset.

In one embodiment of the system, the non-monetary digital asset may be advertised for sell. A minimum valuation for the non-monetary digital asset acceptable to the user may be determined. An offer for the non-monetary digital asset may be received from one or more potential buyers. The buyer may be selected based on a largest offer greater than or equal to the minimum valuation. The advertising of the non-monetary digital asset for sell may comprise identifying a type of the non-monetary digital asset, searching a database for a buyer who has indicated a desire to buy the type of the non-monetary digital asset, and providing the buyer information associated with the non-monetary digital asset.

In one embodiment of the system, a retirement goal for the user may be determined. A shortfall amount in the retirement income growth to meet the retirement goal may be estimated. An impact on the retirement income growth based on selling the non-monetary digital asset at the market value price may be estimated. One or more non-monetary digital assets may be identified for sell so as to reduce the shortfall amount in the retirement income growth. The one or more non-monetary digital assets may then be sold at the market value price.

In one embodiment of the system, the retirement income growth may be estimated based on selling the non-monetary digital asset at the market value price. A future market value price for non-monetary digital asset may be estimated. A recommendation to sell the non-monetary digital asset based on a greater value of the estimated retirement income growth for selling the non-monetary digital asset at the market value price than the estimated future market value price for non-monetary digital asset may be provided to the user.

In one embodiment of the system, the expiration date for the non-monetary digital asset may be determined. A threshold sell after date for the non-monetary digital asset may be determined. The non-monetary digital asset may then be automatically sold after the threshold sell after date but before an expiration date for the non-monetary digital asset.

In another exemplary embodiment, the present application is related to a system for generating funds for retirement income growth using non-monetary digital assets. Information about a user may be gathered by a processor in a computing device. The processor may determine a non-monetary digital asset associated with the user based on the user information. The non-monetary digital asset may be categorized based on a type of the non-monetary digital asset. A market price for the non-monetary digital asset may be determined from a plurality of data sources. A buyer for the non-monetary digital asset may be determined. The non-monetary digital asset may be sold to the buyer at the market value price. The proceeds from selling the non-monetary digital asset may be placed into a retirement account associated with the user. A memory may be configured to contain a database of one or more potential buyers for the non-monetary digital asset based on the type of the non-monetary digital asset.

In one embodiment of the system, the retirement income growth may be estimated based on selling the non-monetary digital asset at the market value price. A future market value price for non-monetary digital asset may be estimated. A recommendation to sell the non-monetary digital asset based on a greater value of the estimated retirement income growth for selling the non-monetary digital asset at the market value price than the estimated future market value price for non-monetary digital asset may be provided to the user.

Further areas of applicability of the present application will become apparent from the detailed description provided hereinafter. It should be understood that the detailed description and specific examples, while indicating the preferred embodiments of the application, are intended for purposes of illustration only and are not intended to limit the scope of the application.

### BRIEF DESCRIPTION OF THE DRAWINGS

Having thus described some example embodiments in general terms, reference will now be made to the accompanying drawings, which are not necessarily drawn to scale, and wherein:

FIG. 1 depicts an example overall view of the environment in which the system and computer-implemented method of the present application generate retirement income from selling a non-monetary digital asset;

FIG. 2 depicts a flowchart diagram describing an exemplary method to generate retirement income from selling a non-monetary digital asset;

FIG. 3 depicts a flowchart diagram describing an exemplary method a user may employ to determine whether to sell a non-monetary digital asset; and

FIG. 4 is a schematic depiction of a computing device suitable for use with example embodiments of the present application.

### DETAILED DESCRIPTION

The following description of the embodiments of the present application is merely exemplary in nature and is in no way intended to limit the application, its application, or uses. The present application has broad potential application and utility, which is contemplated to be adaptable across a wide range of industries. For example, it is contemplated that financial services companies, insurance companies, and/or other institutions and individuals would have use for the present application. The following description is provided herein solely by way of example for purposes of providing an enabling disclosure but does not limit the scope or substance of the application.

Some example embodiments now will be described more fully hereinafter with reference to the accompanying drawings, in which some, but not all embodiments are shown. Indeed, the examples described and pictured herein should not be construed as being limiting as to the scope, applicability or configuration of the present disclosure. Like reference numerals refer to like elements throughout. Furthermore, as used herein, the term “or” is to be interpreted as a logical operator that results in true whenever one or more of its operands are true. As used herein, “operable coupling” should be understood to relate to direct or indirect connection that, in either case, enables at least a functional interconnection of components that are operably coupled to each other.

As used in herein, the terms “component,” “module,” and the like are intended to include a computer-related entity, such as but not limited to hardware, firmware, or a combination of hardware and software. For example, a component or module may be, but is not limited to being, a processor, a process running on a processor, an object, an executable program, a thread of execution, and/or a computer. By way of example, both an application running on a computing device and/or the computing device can be a component or module. One or more components or modules can reside within a process and/or thread of execution and a component/module may be localized on one computer and/or distributed between two or more computers. In addition, these components can execute from various computer readable media having various data structures stored thereon. The components may communicate by way of local and/or remote processes such as in accordance with a signal having one or more data packets, such as data from one component/module interacting with another component/module in a local system, distributed system, and/or across a network such as the Internet with other systems by way of the signal. Each respective component/module may perform one or more functions that will be described in greater detail herein. However, it should be appreciated that although this example is described in terms of separate modules corresponding to various functions performed, some examples may not necessarily utilize modular architectures for employment of the respective different functions. Thus, for example, code may be shared between different modules, or the processing circuitry itself may be configured to perform all of the functions described as being associated with the components/modules described herein. Furthermore, in the context of this disclosure, the term “module” should not be understood as a nonce word to identify any generic means for performing functionalities of the respective modules. Instead, the term “module” should be understood to be a modular component that is specifically configured in, or can be operably coupled to, the processing circuitry to modify the behavior and/or capability of the processing circuitry based on the hardware and/or software that is added to or otherwise operably coupled to the processing circuitry to configure the processing circuitry accordingly.

Unless otherwise defined, all terms, including technical and scientific terms, used herein have the same meaning as commonly understood by one of ordinary skill in the art to which this present application belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Exemplary embodiments of the present application relate to a system and computer-implemented method for use in generation of retirement income from selling non-monetary digital assets. With the present application, retirement income may be obtained from selling a non-monetary digital asset affiliated with a user. As a result of the present invention, the user may be able to obtain retirement income from selling a non-monetary digital asset before it expires, even if the non-monetary digital asset is de minimis in value to the user.

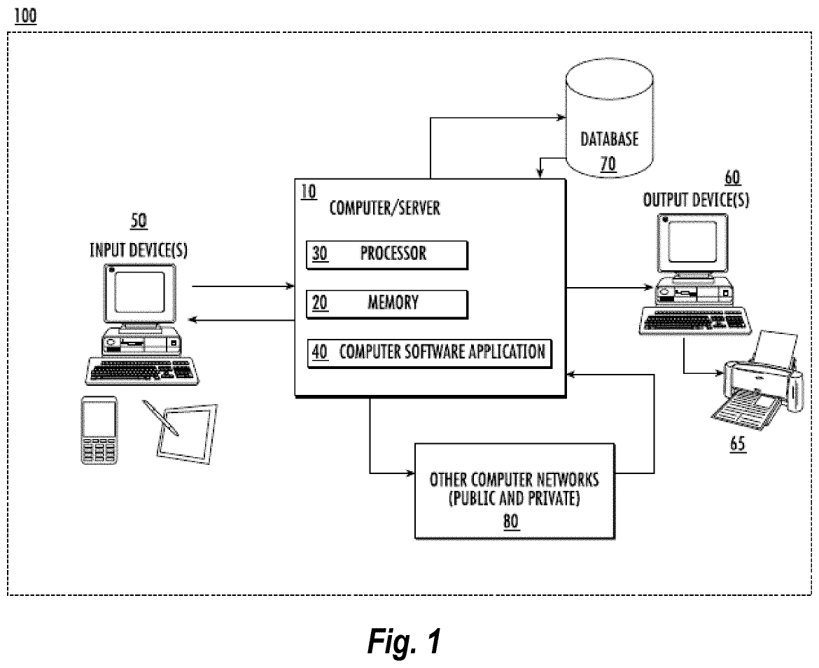

FIG. 1 depicts an example overall view of the environment in which the system and computer-implemented method of the present application operate to generate retirement income growth from selling a non-monetary digital asset. As shown in FIG. 1, the networked computer system 100 of the present application may generally comprise at least one computer or server 10 having memory 20 and a processor 30 for processing data and for executing instructions and programmed computer methods. The networked computer system 100 may include a computer software application 40 comprised of one or more programmed computer software modules executable by the processor 30, an input device 50, for example, a computer, tablet, and/or mobile device for inputting information and data to the computer/server 10, and an output device 60, for example, a computer, tablet, mobile device, and/or a printer 65 for displaying information and data. The computer system 100 may comprise a database 70 for storing information or may be communicatively connected with a database 70 for storing information.

In a preferred aspect of the present application, the computer system 100 is communicatively connected to other computer systems and public and private computer networks 80 such as the internet. The computer networks may have access to public and private data and information. The computer system 100 of the present application may operate in a wireless communication network and with mobile devices, for example, personal data assistants (PDAs), mobile phones, tablets, and other similar devices.

The computer-implemented method of the present application may generate retirement income for an identified third party or client, referred to herein as a user.

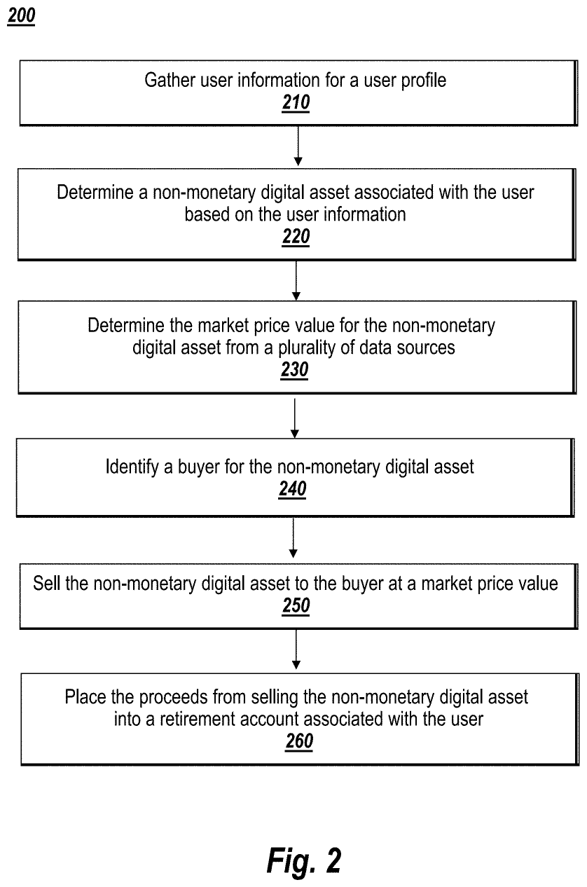

FIG. 2 depicts a flowchart diagram describing an exemplary method for generating of retirement income from selling a non-monetary digital asset. In accordance with the present application, the method 200 comprises, at step 210, gathering information associated with the user. The gathered user information may be referred to as a user profile. The user may input the information directly into a software application being controlled by a processor in a computing device. For example, the processor may provide the user with a series of questions in the form of a questionnaire. The information for the user may also be gathered indirectly, for example, through a financial planner or advisor.

The processor may gather user information from a plurality of data sources, for example, from the user, user accounts, the user's employer, private networks, for example, an investment company, and/or public networks, for example, the internet. The user information may comprise user personnel information, for example, the user's age and/or user life events such as a wedding, family planning, retirement interests, and/or educational interests for the user and/or the user's dependents. The user information may comprise a user goal, for example, a retirement goal, a life goal, an income goal, and/or an asset goal. The user information may comprise financial information, for example bank accounts, investment accounts, retirement accounts, user income, and/or estimated user income potential. The user information may comprise information on the user's financial risk tolerance. The user information may comprise user asset related information, for example information on businesses, properties, and/or vehicles. The user information may comprise expense related information, for example, fixed expenses, purchase history data, receipts, and/or anticipated expenses. The user information may comprise work related information, for example, information pertaining to the user's career and/or current job. The user information may comprise geographic related information, for example, user travel data, a geographic preference, and/or a preferred retirement location. The user information may comprise user lifestyle information and/or demographic preferences, for example, user preferred entertainment, hobbies, and/or user interests. The user information may comprise user social media interests, for example, social media commentary, postings, online activity, and/or research on potential assets to be acquired. Information and data associated with the user may be input into the processor and compiled to build a user profile.

At step 220, the processor may determine a non-monetary digital asset associated with a user based on the user information. The non-monetary digital asset associated with the user may comprise at least one of a service account, intellectual capital, and/or relational capital.

A non-monetary digital asset may be associated with a service account, for example, frequent flyer miles, hotel points, car rental points, retailer reward points, electronic coupons, a limited service such as cell phone minutes, and the like. The processor may search the user information for an activity and/or an account of the user based on a type of non-monetary digital asset, such as frequent flyer miles. For example, the processor may search user receipts to determine if the user has traveled during a previous time period. The processor may determine if the user belongs to a rewards program. If a user does not belong to a reward program, the processor may determine if the user is eligible for a reward program benefit based on a date of a receipt, a type of item purchased, and/or reward program information, such as the reward program rules and restrictions.

A non-monetary digital asset for the user may be associated with intellectual capital information. A user's intellectual capital may comprise an intangible asset available to the user, for example, a digital file of information. A non-monetary digital asset for the user may be associated with relational capital. For example, the user may know how two people relate digitally, for example, by email addresses, and may be willing to contact a particular person on behalf of third party, for example, via an email.

At step 230, the market price value by the non-monetary digital asset may be determined from a plurality of data sources. The market price may be determined from selling price information associated with the sale of a similar non-monetary digital asset and a redemption value associated with the non-monetary digital asset. The selling price information may be obtained, for example, from an internet posting of a similar item for sell. The redemption value may be obtained, for example, from the service provider's website. For example, an airline may be advertising a fare online for a particular price. The user may be willing to sell airline points to a third party buyer. An internet posting may advertise a similar item and/or a buyer may be requesting a similar item for a suggested price. The price may be determined on a cost value per point basis. As such, the processor may be able to determine the market price associated with the non-monetary digital asset from a plurality of data sources.

At step 240, a buyer for the non-monetary digital asset may be identified. Identifying the buyer may comprise advertising the non-monetary digital asset for sell. For example, a description of the non-monetary digital asset may be placed on a website, an internet bulletin board, a blog, and/or the like. Identifying the buyer may comprise searching a database for a buyer who has indicated a desire to buy a type of the non-monetary digital asset, for example, airline miles, and providing the buyer information associated with the non-monetary digital asset. The database containing information about potential buyers may be contained in a memory accessible by the processor.

An offer to buy the non-monetary digital asset may be received from one or more potential buyers. The buyer may be selected based on an earliest offer received. A minimum valuation for the non-monetary digital asset acceptable to the user may be determined. The buyer may be selected based on a largest offer greater than or equal to the minimum valuation for the non-monetary digital asset acceptable to the user.

At step 250, the non-monetary digital asset may be sold to the buyer at the market price. The transfer of the non-monetary digital asset may occur, for example, using a transaction application on the internet. The buyer may provide a digital monetary, i.e. the proceeds, to the user who sold the non-monetary digital asset.

At step 260, the proceeds from selling the non-monetary digital asset may be placed into a retirement account associated with the user. The retirement account associated with the user may be, for example, an individual retirement account (IRA).

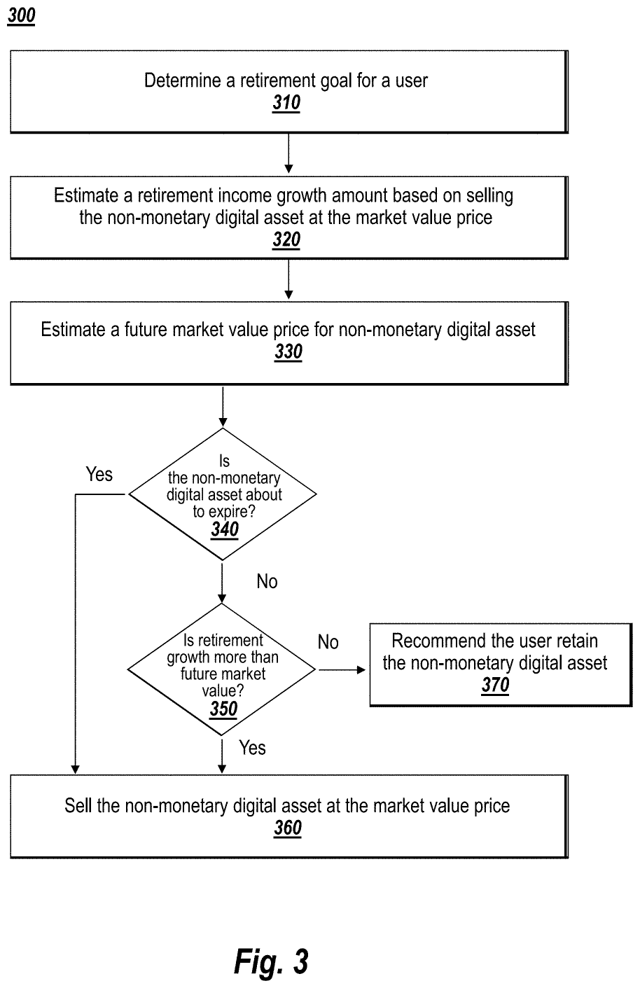

FIG. 3 depicts a flowchart diagram describing an exemplary method 300 a user may use to determine whether to sell a non-monetary digital asset. At step 310, a processor may determine a retirement goal for a user. The processor may estimate a shortfall amount in the retirement income growth to meet the retirement goal for the user based on the user information.

At step 320, the processor may estimate a retirement income growth amount based on selling a non-monetary digital asset at a market value price. The retirement income growth amount may be based on an existing user investment strategy obtained from the user information.

At step 330, the processor may estimate a future market value price for the non-monetary digital asset. For example, the processor may estimate a future price of an airline ticket based on historical trends and/or internet information, such as jet fuel prices. When estimating the future market value price for the non-monetary digital asset, the processor may take into account the financial stability of the service provider. The processor may take into account expiration dates associated with the non-monetary digital asset. The processor may take into account user information. For example, if the user has indicated they have no plans to travel, then the processor may estimate a lower future market value price for a non-monetary digital asset associated with an airline.

At step 340, the processor may determine when a non-monetary digital asset expires. A threshold sell after date for the non-monetary digital asset may be determined. For example, the user may desire to hold onto the non-monetary digital asset for a period of time and/or the user may know they do not plan to redeem the non-monetary digital asset after a certain date. The non-monetary digital asset may then be automatically sold by the processor after the threshold sell after date but before an expiration date. By selling the non-monetary digital asset prior to the expiration date of the non-monetary digital asset, some value for the non-monetary digital asset may be obtained for the user.

At step 350, the processor may determine whether the retirement income growth amount based on selling the non-monetary digital asset at the market value price is anticipated to be higher than the future market value price for the non-monetary digital asset.

At step 360, if the retirement income growth amount based on selling the non-monetary digital asset at the market value price is anticipated to be higher than the future market value price for the non-monetary digital asset, then the non-monetary digital asset may be sold at the market value price.

At step 370, if the retirement income growth amount based on selling the non-monetary digital asset at the market value price is not anticipated to be higher than the future market value price for the non-monetary digital asset, the processor may recommend that the user retain the non-monetary digital asset and/or redeem the non-monetary digital asset at a future date.

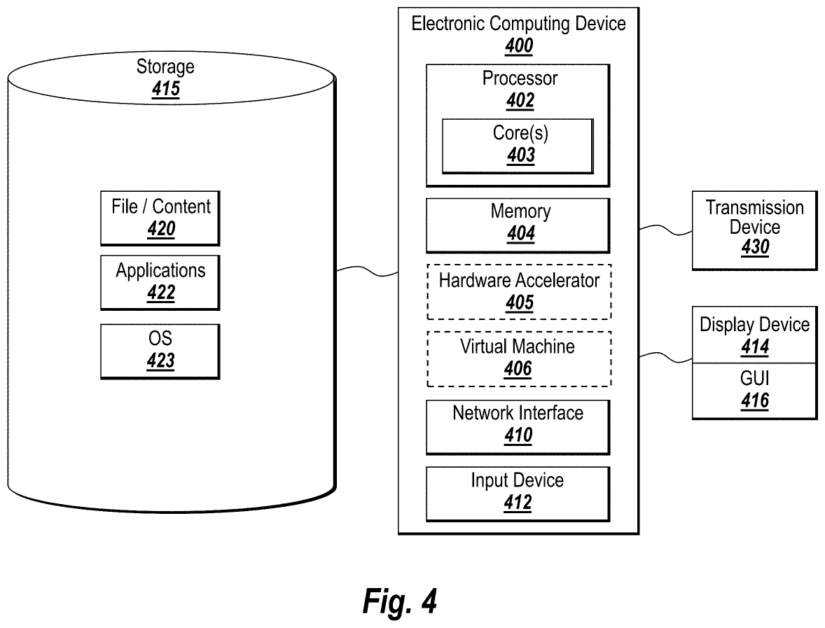

FIG. 4 depicts an example of an electronic device, computing device, and/or processing device 400 suitable for use with one or more embodiments of the present application. The electronic computing device 400 may be located in networked computer system.

The electronic device 400 may take many forms, including but not limited to a computer, workstation, server, network computer, quantum computer, optical computer, Internet appliance, mobile device, a pager, a tablet computer, a smart sensor, application specific processing device (ASIC), a processing device containing a processor, etc.

The electronic device 400 is illustrative and may take other forms. For example, an alternative implementation of the electronic device 400 may have fewer components, more components, or components that are in a configuration that differs from the configuration of FIG. 4. The components of FIG. 4 and/or other figures described herein may be implemented using hardware based logic, software based logic and/or logic that is a combination of hardware and software based logic (e.g., hybrid logic); therefore, the components illustrated in FIG. 4 and/or other figures are not limited to a specific type of logic.

The processor 402 may include hardware based logic or a combination of hardware based logic and software to execute instructions on behalf of the electronic device 400. The processor 402 may include logic that may interpret, execute, and/or otherwise process information contained in, for example, the memory 404. The processor 402 may be made up of one or more processing cores 403. The information may include computer-executable instructions and/or data that may implement one or more embodiments of the application. The processor 402 may comprise a variety of homogeneous or heterogeneous hardware. The hardware may include, for example, some combination of one or more processors, microprocessors, field programmable gate arrays (FPGAs), application specific instruction set processors (ASIPs), application specific integrated circuits (ASICs), complex programmable logic devices (CPLDs), graphics processing units (GPUs), or other types of processing logic that may interpret, execute, manipulate, and/or otherwise process the information. Moreover, the processor 402 may include a system-on-chip (SoC) or system-in-package (SiP). One or more processors 402 may reside in the electronics device 400. An example of a processor 402 is the Intel® Core i3 series of processors available from Intel Corporation, Santa Clara, Calif.

The electronic device 400 may include one or more tangible non-transitory computer-readable storage media for storing one or more computer-executable instructions or software that may implement one or more embodiments of the application. The non-transitory computer-readable storage media may be, for example, the memory 404 or the storage 415. The memory 404 may comprise a RAM that may include RAM devices that may store the information. The RAM devices may be volatile or non-volatile and may include, for example, one or more DRAM devices, flash memory devices, SRAM devices, zero-capacitor RAM (ZRAM) devices, twin transistor RAM (TTRAM) devices, read-only memory (ROM) devices, ferroelectric RAM (FeRAM) devices, magneto-resistive RAM (MRAM) devices, phase change memory RAM (PRAM) devices, or other types of RAM devices.

One or more computing devices 400 may include a virtual machine (VM) 406 for executing the instructions loaded in the memory 404. A virtual machine 406 may be provided to handle a process running on multiple processors so that the process may appear to be using only one computing resource rather than multiple computing resources. Virtualization may be employed in the electronic device 400 so that infrastructure and resources in the electronic device may be shared dynamically. Multiple VMs 406 may be resident on a single computing device 400.

A hardware accelerator 405 may be implemented in an ASIC, FPGA, or some other device. The hardware accelerator 405 may be used to reduce the general processing time of the electronic device 400.

The electronic device 400 may include a network interface 410 to interface to a Local Area Network (LAN), Wide Area Network (WAN), Ethernet domain, and/or the Internet through a variety of connections including, but not limited to, standard telephone lines, LAN or WAN links (e.g., T1, T3, 56 kb, X.25), broadband connections (e.g., integrated services digital network (ISDN), Frame Relay, asynchronous transfer mode (ATM), wireless connections (e.g., 502.11), RF connections, high-speed interconnects (e.g., InfiniBand, gigabit Ethernet, Myrinet) or some combination of any or all of the above. The network interface 410 may include a built-in network adapter, network interface card, personal computer memory card international association (PCMCIA) network card, card bus network adapter, wireless network adapter, universal serial bus (USB) network adapter, modem or any other device suitable for interfacing the electronic device 400 to any type of network capable of communication and performing the operations described herein.

The electronic device 400 may include one or more user input devices 412, for example a keyboard, a multi-point touch interface, a pointing device (e.g., a mouse), a gyroscope, an accelerometer, a haptic device, a tactile device, a neural device, a microphone, or a camera that may be used to receive input from, for example, a user. Note that electronic device 400 may include other suitable I/O peripherals.

The input devices 412 may allow a user to provide input that is registered on a visual display device 414. A graphical user interface (GUI) 416 may be shown on the display device 414.

A storage device 415 may also be associated with the computer 400. The storage device 415 may be accessible to the processor 402 via an I/O bus. The information in the storage device 415 may be executed, interpreted, manipulated, and/or otherwise processed by the processor 402. The storage device 415 may include, for example, a storage device, such as a magnetic disk, optical disk (e.g., CD-ROM, DVD player), random-access memory (RAM) disk, tape unit, and/or flash drive. The information may be stored on one or more non-transient tangible computer-readable media contained in the storage device. This media may include, for example, magnetic discs, optical discs, magnetic tape, and/or memory devices (e.g., flash memory devices, static RAM (SRAM) devices, dynamic RAM (DRAM) devices, or other memory devices). The information may include data and/or computer-executable instructions that may implement one or more embodiments of the application.

The storage device 415 may store any modules, outputs, displays, files, content, and/or information 420 provided in example embodiments. The storage device 415 may store applications 422 for use by the computing device 400 or another electronic device. The applications 422 may include programs, modules, or software components that allow the electronic device 400 to perform tasks. Examples of applications include a questionnaire program to allow a user to input user information, a data mining application to obtain user information for a data source, word processing software, shells, Internet browsers, productivity suites, and programming software. The storage device 415 may store additional applications for providing additional functionality, as well as data for use by the computing device 400 or another device. The data may include files, variables, parameters, images, text, and other forms of data.

The storage device 415 may further store an operating system (OS) 423 for running the computing device 400. Examples of OS 423 may include the Microsoft® Windows® operating systems, the Unix and Linux operating systems, the MacOS® for Macintosh computers, an embedded operating system, such as the Symbian OS, a real-time operating system, an open source operating system, a proprietary operating system, operating systems for mobile electronic devices, or other operating system capable of running on the electronic device and performing the operations described herein. The operating system may be running in native mode or emulated mode.

A transmission device 430 may also be associated with the computer 400. The transmission device 430 may be capable of transmitting and receiving information over radio frequencies using common protocols and/or transmitting and receiving information over Ethernet domains using internet devices. A transmission device 430 may be device comprising a media access controller, for example, an internet PHY device.

One or more embodiments of the application may be implemented using computer-executable instructions and/or data that may be embodied on one or more non-transitory tangible computer-readable mediums. The mediums may be, but are not limited to, a hard disk, a compact disc, a digital versatile disc, a flash memory card, a Programmable Read Only Memory (PROM), a Random Access Memory (RAM), a Read Only Memory (ROM), Magnetoresistive Random Access Memory (MRAM), a magnetic tape, or other computer-readable media.

One or more embodiments of the application may be implemented in a programming language. Some examples of languages that may be used include, but are not limited to, Python, C, C++, C#, Java, JavaScript, a hardware description language (HDL), unified modeling language (UML), and Programmable Logic Controller (PLC) languages. Further, one or more embodiments of the application may be implemented in a hardware description language or other language that may allow prescribing computation. One or more embodiments of the application may be stored on or in one or more mediums as object code. Instructions that may implement one or more embodiments of the application may be executed by one or more processors. Portions of the application may be in instructions that execute on one or more hardware components other than a processor.

It is understood that the present application may be implemented in a distributed or networked environment. For example, information may be provided and manipulated at a central server, while a user interacts with the information through a terminal or input/output device.

Many modifications and other examples of the embodiments set forth herein will come to mind to one skilled in the art to which these embodiments pertain having the benefit of the teachings presented in the foregoing descriptions and the associated drawings. Therefore, it is to be understood that example embodiments are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

It is intended that the present application not be limited to the particular embodiments disclosed above, but that the present application will include any and all particular embodiments and equivalents falling within the scope of the following appended claims.

1. A computer-implemented method for generating funds for retirement income growth using a non-monetary digital asset, the method comprising:
gathering, by a processor, information about a user from a plurality of data sources in a plurality of formats, including:
transmitting a request over a network to a first data source of the plurality of data sources using a network interface;
receiving a response from the first data source in a first format of the plurality of formats;
transmitting a request over the network to a second data source of the plurality of data sources using the network interface; and
receiving a response from the second data source in a second format of the plurality of formats;
compiling, by the processor, the user information using at least one of the plurality of formats;
storing, by the processor, the compiled user information in a database;
determining, by the processor using the compiled user information, user eligibility for the non-monetary digital asset having an associated membership program wherein the user is not a current member of the associated membership program, the determination based on user payment activity and eligibility rules of the associated membership program, wherein the non-monetary digital asset includes a rewards program from a service provider, and wherein the non-monetary digital asset includes one or more of frequent flyer miles; hotel points, car rental points; credit card rewards, retailer reward points, electronic coupons or cell phone minutes;
determining, by the processor, the non-monetary digital asset is associated with relational capital of the user based on the user information and the user eligibility, wherein the relational capital includes contact information of an individual retained by the user and an indicated willingness of the user to contact the individual on behalf of a third party;
determining, by the processor, a market value price and an estimated future market value price for the non-monetary digital asset from a plurality of data sources, including evaluating financial stability of the service provider and using input by the user from a graphical user interface indicating a level of interest in using the non-monetary digital asset;
identifying, by the processor, a buyer for the non-monetary digital asset;
automatically selling, by the processor, the non-monetary digital asset to the buyer at the market value price based on a greater value of an estimated retirement income growth for selling the non-monetary digital asset at the market value price than the estimated future market value price for the non-monetary digital asset; and
automatically digitally depositing, by the processor, monetary proceeds from selling the non-monetary digital asset into an existing retirement account associated with the user.

2. The method according to claim 1, wherein the information about the user comprises at least one of financial information, career information, and expenditure information.

3. The method according to claim 1, wherein the non-monetary digital asset associated with the user comprises at least one of a service account, intellectual capital, and relational capital.

4. The method according to claim 1, wherein the identifying of the buyer comprises:
advertising the non-monetary digital asset for sell;
receiving an offer for the non-monetary digital asset from one or more potential buyers; and
selecting the buyer based on an earliest offer received.

5. The method according to claim 4, wherein the advertising of the non-monetary digital asset for sell comprises:
identifying a type of the non-monetary digital asset;
searching a database for a buyer who has indicated a desire to buy the type of the non-monetary digital asset; and
providing the buyer information associated with the non-monetary digital asset.

6. The method according to claim 1, wherein the market value price is determined from selling price information associated with a similar non-monetary digital asset and a redemption value associated with the non-monetary digital asset.

7. The method according to claim 1, the method further comprising:
determining a retirement goal for the user;
estimating a shortfall amount in the retirement income growth to meet the retirement goal;
estimating an impact on the retirement income growth based on selling the non-monetary digital asset at the market value price;
identifying the non-monetary digital asset to be sold; and
selling the non-monetary digital assets at the market value price to reduce the shortfall amount in the retirement income growth.

8. The method according to claim 1, the method further comprising:
estimating the retirement income growth based on selling the non-monetary digital asset at the market value price;
estimating a future market value price for the non-monetary digital asset; and
recommending selling the non-monetary digital asset based on a greater value of the estimated retirement income growth for selling the non-monetary digital asset at the market value price than the estimated future market value price for non-monetary digital asset.

9. The method according to claim 1, the method further comprising:
determining when the non-monetary digital asset expires;
determining a threshold sell after date for the non-monetary digital asset; and
automatically selling the non-monetary digital asset after the threshold sell after date but before an expiration date.

10. A system for generating funds for retirement income growth using a non-monetary digital asset, the system comprising:
a processor configured to:
gather information about a user from a plurality of data sources in a plurality of formats, including:
transmitting a request over a network to a first data source of the plurality of data sources using a network interface;
receiving a response from the first data source in a first format of the plurality of formats;
transmitting a request over the network to a second data source of the plurality of data sources using the network interface; and
receiving a response from the second data source in a second format of the plurality of formats;
compile the user information using at least one of the plurality of formats;
store the compiled user information in a database;
determine, using the compiled user information, user eligibility for the non-monetary digital asset having an associated membership program wherein the user is not a current member of the associated membership program, the determination based on user payment activity and eligibility rules of the associated membership program, wherein the non-monetary digital asset includes a rewards program from a service provider, and wherein the non-monetary digital asset includes one or more of frequent flyer miles, hotel points, car rental points, credit card rewards, retailer reward points, electronic coupons or cell phone minutes;
determine the non-monetary digital asset is associated with relational capital of the user based on the user information and the user eligibility, wherein the relational capital includes contact information of an individual retained by the user and an indicated willingness of the user to contact the individual on behalf of a third party;
determine a market value price and an estimated future market value price for the non-monetary digital asset from a plurality of data sources, including evaluating financial stability of the service provider and using input by the user from a graphical user interface indicating a level of interest in using the non-monetary digital asset;
identify a buyer for the non-monetary digital asset;
automatically sell the non-monetary digital asset to the buyer at the market value price based on a greater value of an estimated retirement income growth for selling the non-monetary digital asset at the market value price than the estimated future market value price for the non-monetary digital asset; and
automatically digitally deposit monetary proceeds from selling the non-monetary digital asset into an existing retirement account associated with the user.

11. The system according to claim 10, wherein the information about the user comprises at least one of financial information, career information, and expenditure information.

12. The system according to claim 10, wherein the non-monetary digital asset associated with the user comprises at least one of a service account, intellectual capital, and relational capital.

13. The system according to claim 10, wherein the processor is furthered configured to:
advertise the non-monetary digital asset for sell;
determine a minimum valuation for the non-monetary digital asset acceptable to the user;
receive an offer for the non-monetary digital asset from one or more potential buyers; and
select the buyer based on a largest offer greater than or equal to the minimum valuation.

14. The system according to claim 13, wherein the advertising of the non-monetary digital asset for sell comprises:
identifying a type of the non-monetary digital asset;
searching a database for a buyer who has indicated a desire to buy the type of the non-monetary digital asset; and
providing the buyer information associated with the non-monetary digital asset.

15. The system according to claim 10, wherein the market value price is determined from selling price information associated with a similar non-monetary digital asset and a redemption value associated with the non-monetary digital asset.

16. The system according to claim 10, wherein the processor is furthered configured to:
determine a retirement goal for the user;
estimate a shortfall amount in the retirement income growth to meet the retirement goal;
estimate an impact on the retirement income growth based on selling the non-monetary digital asset at the market value price;
identify the non-monetary digital asset to be sold; and
sell the non-monetary digital asset at the market value price to educe the shortfall amount in the retirement income growth.

17. The system according to claim 10, wherein the processor is furthered configured to:
estimate the retirement income growth based on selling the non-monetary digital asset at the market value price;
estimate a future market value price for non-monetary digital asset; and
recommend selling the non-monetary digital asset based on a greater value of the estimated retirement income growth for selling the non-monetary digital asset at the market value price than the estimated future market value price for non-monetary digital asset.

18. The system according to claim 10, wherein the processor is furthered configured to:
determine when the non-monetary digital asset expires;
determine a threshold sell after date for the non-monetary digital asset; and
automatically sell the non-monetary digital asset after the threshold sell after date but before an expiration date.

19. A system for generating funds for retirement income growth using a non-monetary digital asset, the system comprising:
a processor configured to:
gather information about a user from a plurality of data sources in a plurality of formats, including:
transmitting a request over a network to a first data source of the plurality of data sources using a network interface;
receiving a response from the first data source in a first format of the plurality of formats;
transmitting a request over the network to a second data source of the plurality of data sources using the network interface; and
receiving a response from the second data source in a second format of the plurality of formats;
compile the user information using at least one of the plurality of formats;
store the compiled user information in a database;
determine, using the compiled user information, user eligibility for the non-monetary digital asset having an associated membership program wherein the user is not a current member of the associated membership program, the determination based on user payment activity and eligibility rules of the associated membership program, wherein the non-monetary digital asset includes a rewards program from a service provider, and wherein the non-monetary digital asset includes one or more of frequent flyer miles, hotel points; car rental points, credit card rewards, retailer reward points, electronic coupons or cell phone minutes;
determine the non-monetary digital asset is associated with relational capital of the user based on the user information and the user eligibility, wherein the relational capital includes contact information of an individual retained by the user and an indicated willingness of the user to contact the individual on behalf of a third party and wherein the non-monetary digital asset is categorized by a type of the non-monetary digital asset;
determine a market value price and an estimated future market value price for the non-monetary digital asset from a plurality of data sources, including evaluating financial stability of the service provider and using input by the user from a graphical user interface indicating a level of interest in using the non-monetary digital asset;
identify a buyer for the non-monetary digital asset based on the type of the non-monetary digital asset;
automatically sell the non-monetary digital asset to the buyer at the market value price based on a greater value of an estimated retirement income growth for selling the non-monetary digital asset at the market value price than the estimated future market value price for the non-monetary digital asset; and
automatically digitally deposit monetary proceeds from selling the non-monetary digital asset into an existing retirement account associated with the user; and
a memory configured to:
contain a database of one or more potential buyers for the non-monetary digital asset based on the type of the non-monetary digital asset.

20. The system according to claim 19, wherein the processor is furthered configured to:
estimate the retirement income growth based on selling the non-monetary digital asset at the market value price;
estimate a future market value price for non-monetary digital asset; and
recommend selling the non-monetary digital asset based on a greater value of the estimated retirement income growth for selling the non-monetary digital asset at the market value price than the estimated future market value price for non-monetary digital asset.
